(19) United States
(12) Patent Application Publication
(10) Pub. No.: US 2009/0102801 A1
(43) Pub. Date: Apr. 23, 2009

(54) METHODS AND DEVICES FOR DISPLAYING AND COLLECTING INFORMATION AT WINDOWS

(75) Inventors: M. Sam Araki, Saratoga, CA (US); Kenneth L. Stutzman, Windsor, CO (US); Donald Araki, San Jose, CA (US); Shozo Kagoshima, Campbell, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ST-Infonox, Inc., San Jose, CA (US)

(21) Appl. No.: 11/873,937

(22) Filed: Oct. 17, 2007

(51) Int. Cl. G06F 3/041

(52) U.S. Cl. 345/173

(57) ABSTRACT

An arrangement is disclosed for displaying and collecting information. A substantially transparent or translucent touchscreen is disposed at an exterior of a window comprised by a building. A display device is disposed at an interior side of the window and has a display visible from the exterior of the building through the touchscreen and window. A controller is provided in communication with the touchscreen and the display device. The controller has instructions for correlating a position activated on the touchscreen with a position of information displayed on the display.

### BACKGROUND OF THE INVENTION

This application relates generally to advertising. More specifically, this application relates to methods and systems for providing information at windows.

There are a number of different reasons for providing information in public or private places. One of the more common is to provide advertising for products, although other forms of information include a variety of notices that may be provided. In some instances, the information may be acquired through an interactive interface. For instance, a display may be provided in which an individual in the area makes a selection from the display and receives more information related to the selection.

In practice, there are a number of challenges associated with providing information as part of an interactive device, particularly in outdoor areas. For instance, there are a number of environmental impacts on devices that are deployed in outdoor areas, where the devices might be subject to high and low temperatures, as well as to precipitation in a variety of forms. Such environmental impacts may be significant.

Some of these challenges are frequently addressed by deploying interactive information devices as part of kiosks, which may provide a certain level of protection from environmental impacts. But such kiosks tend to be relatively large, and may require significant effort to deploy and install. Furthermore, the areas in which they might be deployed are frequently to ordinance restrictions, requiring that a permit be obtained before deployment.

There is accordingly a general need in the art for methods and devices of providing information that avoid some of these challenges.

### BRIEF SUMMARY OF THE INVENTION

Embodiments of the invention provide an arrangement for displaying and collecting information. A substantially transparent or translucent touchscreen is disposed at an exterior of a window comprised by a building. A display device is disposed at an interior side of the window and has a display visible from the exterior of the building through the touchscreen and window. A controller is provided in communication with the touchscreen and the display device. The controller has instructions for correlating a position activated on the touchscreen with a position of information displayed on the display.

In some embodiments, the controller is in wireless communication with the touchscreen. In other embodiments, a battery is disposed at the exterior side of the window and in electrical communication with the touchscreen to provide power to the touchscreen. A solar cell may sometimes also be disposed at the exterior side of the window and in electrical communication with the battery to provide energy to the battery. A substantially transparent or translucent protective covering may be disposed over the touchscreen to protect the touchscreen.

A picture frame may also be disposed at the exterior side of the window and holding the touchscreen. A window frame might hold the window, with the picture frame being integrated into the window frame.

In certain embodiments, the controller further has instructions for executing diagnostic functions to evaluate a condition of the touchscreen.

The arrangements described above may be used in methods for displaying and collecting information. For example, information may be displayed on the display and a touch detected on the touchscreen. A position of the touch on the touchscreen is then correlated with a position of the information displayed on the display using the controller.

### BRIEF DESCRIPTION OF THE DRAWINGS

A further understanding of the nature and advantages of the present invention may be realized by reference to the remaining portions of the specification and the drawings wherein like reference labels are used throughout the several drawings to refer to similar components.

FIGS. 1A and 1B respectfully provide front and views of a device for displaying and collecting information at a window; and

FIG. 2 is a flow diagram summarizing methods of displaying and collecting information at windows in accordance with an embodiment of the invention.

### DETAILED DESCRIPTION OF THE INVENTION

Embodiments of the invention provide an arrangement in which information is displayed and/or collected at a window. The window is made of a material that is substantially transparent or is translucent at optical wavelengths. Usually the window is comprised by a building and separates an interior of the building from an exterior of the building. The arrangement comprises a display that is disposed at the window on an interior side of the building and a touchscreen that is disposed at the window on an exterior side of the building. A user who wishes to interact with the arrangement may touch the touchscreen with a controller then determining what action is to be taken based on a correlation of the relative touchscreen and display positions.

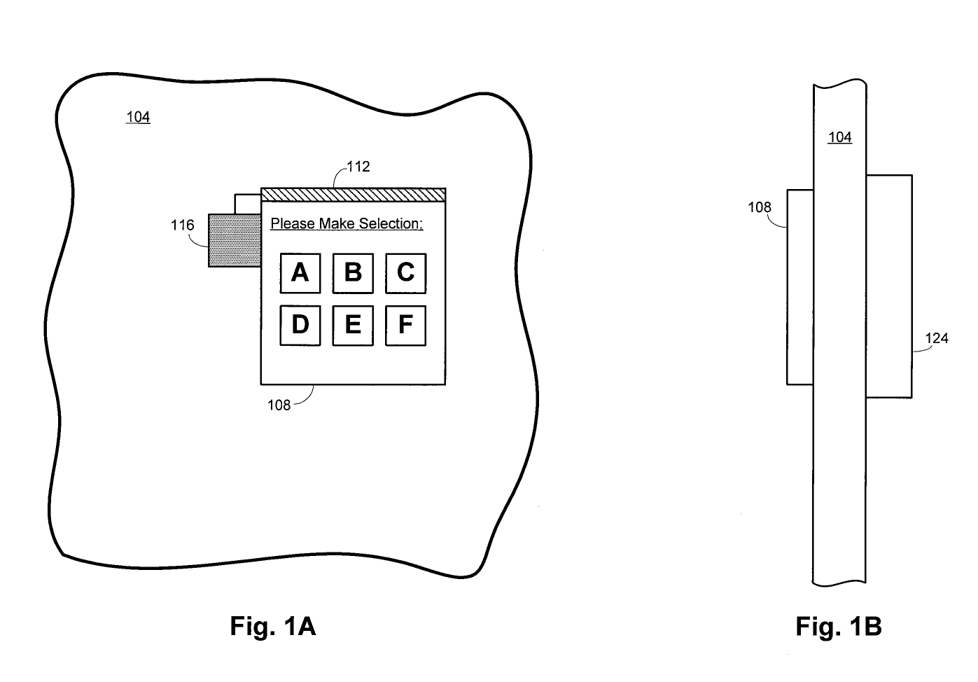

An example of the structure that may be used is illustrated with FIGS. 1A and 1B, which respectively show front and side views of the arrangement. The window 104 separates an interior of a building from an exterior of the building. Selections that are offered to a user are presented on the display 124 disposed at the interior of the building and are visible from the exterior of the building through the window 104 and through the touchscreen. Because it is disposed on the exterior side of the building, the touchscreen may be accessed by a user.

The touchscreen may be powered with a battery 116. In different embodiments, the battery may be subject to periodic replacement or may be a rechargeable battery that is trickle-charged with the use of another power source. For instance, in one embodiment, a solar cell 112 is provided in electrical communication with the battery 116 and supplies recharge energy derived from solar radiation. Such a solar cell 112 may thus be disposed with the touchscreen on the exterior side of the building.

Examples of buildings that might benefit from such arrangements include shops, restaurants, museums, banks, and a variety of other types of buildings. For example, a restaurant might include an arrangement to provide a mechanism for potential customers to review menu offerings. Such an arrangement permits the menu options to be changed more frequently and more easily than conventional postings of paper menus outside restaurants. Shops might include the arrangement as a mechanism for potential customers to review inventory. Banks might include such an arrangement so that customers may review interest-rate offerings and currency-exchange values, for example. There is considerable diversity in the nature and type of information that may be provided to those outside the building depending on the nature of activities that take place within the building.

A variety of additional features may be included in specific embodiments of the invention. For instance, in some instances, a frame is attached to the exterior of the window, with the touchscreen disposed within the frame. In other instances, a picture frame may be integrated into the window frame. In cases where a picture frame is included, the battery or a battery-pack replacement may be disposed within the frame. Generally, a protective layer of some kind will be provided over the touchscreen to prevent the touchscreen from being damaged. A variety of diagnostics may also be provided to identify any problems associated with the functionality of the touchscreen, the battery voltage, or with other components of the arrangement.

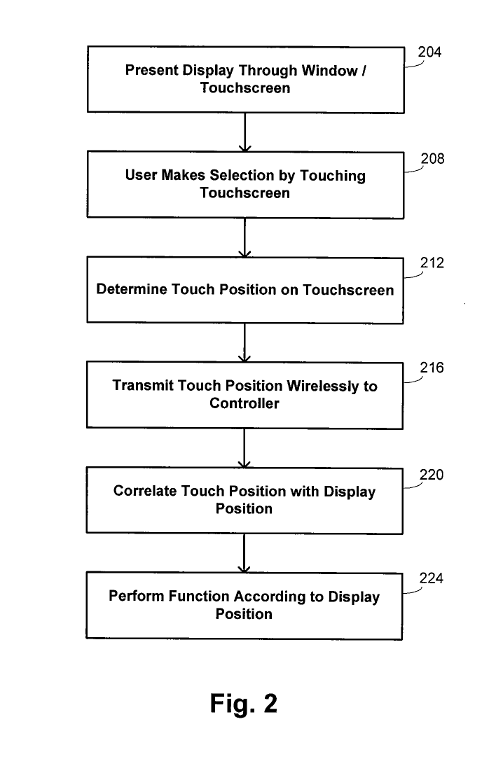

FIG. 2 provides a flow diagram that summarizes methods of displaying and collecting information in accordance with embodiments of the invention. Such methods may use an arrangement like that shown in FIG. 1, but may also use various alternative arrangements, as will be evident to those of skill in the art.

The methods begin at block 204 by presenting a display from a position interior to a building through a window and a touchscreen. The display is thus visible to users who may be located outside the building. The user makes a selection from an offering shown on the display at block 208 by touching the touchscreen. The arrangement is preferably such that the experience of the user is not meaningfully different from the use of any touchscreen, notwithstanding the fact that different portions of the arrangement are inside and outside of the building.

A determination of the position touched is made at block 212 and this position is transmitted wirelessly to a controller that coordinates operation of the arrangement. A correlation is made with the position of information displayed on the display at block 220, such as by determining Cartesian coordinates of the position touched and comparing these with Cartesian coordinates of the display. Once the position has been correlated with the display position in this way, a function may be performed at block 224 in accordance with the identified selection.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. An arrangement for displaying and collecting information, the arrangement comprising:
a substantially transparent or translucent touchscreen disposed at an exterior side of a window comprised by a building;
a display device disposed at an interior side of the window and having a display visible from the exterior of the building through the touchscreen and window; and
a controller in communication with the touchscreen and the display device, the controller having instructions for correlating a position activated on the touchscreen with a position of information displayed on the display.

2. The arrangement recited in claim 1 wherein the controller is in wireless communication with the touchscreen.

3. The arrangement recited in claim 1 further comprising a battery disposed at the exterior side of the window and in electrical communication with the touchscreen to provide power to the touchscreen.

4. The arrangement recited in claim 3 further comprising a solar cell disposed at the exterior side of the window and in electrical communication with the battery to provide energy to the battery.

5. The arrangement recited in claim 1 further comprising a substantially transparent or translucent protective covering disposed over the touchscreen to protect the touchscreen.

6. The arrangement recited in claim 1 further comprising a picture frame disposed at the exterior side of the window and holding the touchscreen.

7. The arrangement recited in claim 6 further comprising a window frame holding the window, wherein the picture frame is integrated into the window frame.

8. The arrangement recited in claim 1 wherein the controller further has instructions for executing diagnostic functions to evaluate a condition of the touchscreen.

9. A method for displaying and collecting information with an arrangement having a substantially transparent or translucent touchscreen disposed at an exterior side of a window comprised by a building, a display device disposed at an interior side of the window and having a display visible from the exterior of the building through the touchscreen and window, and a controller in communication with the touchscreen and the display device, the method comprising:
displaying information on the display;
detecting a touch on the touchscreen; and
correlating a position of the touch on the touchscreen with a position of the information displayed on the display using the controller.

10. The method recited in claim 9 wherein detecting the touch on the touchscreen comprises receiving a wireless signal from the touchscreen at the controller.

11. The method recited in claim 9 further comprising providing power to the touchscreen with a battery disposed at the exterior side of the window and in electrical communication with the touchscreen.

12. The method recited in claim 11 further comprising:
generating energy with a solar cell disposed at the exterior side of the window; and
providing the generated energy to the battery.

13. The method recited in claim 9 further comprising executing diagnostic functions with the controller to evaluate a condition of the touchscreen.
